(19) United States
(12) Patent Application Publication
(10) Pub. No.: US 2026/0195463 A1
(43) Pub. Date: Jul. 9, 2026

(54) ASSET MANAGEMENT SYSTEM AND ASSOCIATED DEVICE AND METHODS

(71) Applicant: Cheyenne Mint, LLC, Lithia, FL (US)

(72) Inventor: Pat Rugg, Lithia, FL (US)

(73) Assignee: Cheyenne Mint, LLC, Lithia, FL (US)

(21) Appl. No.: 19/009,094

(22) Filed: Jan. 3, 2025

(51) Int. Cl. G06F 21/60

(52) U.S. Cl. CPC G06F 21/602

(57) ABSTRACT

A system for asset management is presented. The system comprises a transaction device. The transaction device may include a body member, a printed circuit board (PCB), a controller, a first co-controller, and one or more of another co-controller. The PCB may store onboard user data associated with remote user data stored by a data center. The first co-controller may store security keys associated with one or more of an asset, the remote user data, and the onboard user data. The one or more other co-controller(s) may store a predetermined subset of the security keys. The PCB may be operable to receive a transaction request from the third-party device. The one or more other co-controller(s) may be operable to perform a verification procedure to generate a verification result signal. The controller may be operable to send a portion of the onboard user data and the transaction request to the data center.

### FIELD OF THE INVENTION

The present invention relates to a system which uses a device for digitally managing one or more assets and performing transactions therewith.

### BACKGROUND OF THE INVENTION

Financial instruments such as debit cards, credit cards, and financial applications for smart phones are well known in the art. Such instruments are utilized to provide methods of accessing to finances and performing monetary transactions alternatively to alternative to carrying physical notes of currencies, e.g., U.S. Dollars, Euros, or British Pounds Sterling. The instruments of the prior art utilize either a magnetic strip, a data chip, or near-field-communication (NFC) in order to provide financial information to a transaction terminal, such as, a transaction terminal of a merchant offering a good or service to the user.

However, the prior art fail to provide an ability to perform transactions with payments using assets other than fiat currencies. For example, the prior art fail to provide for an instrument capable of liquidating all or a portion of a valuable asset into one or more currencies and to provide that currency for a transactions being concurrently conducted by the user of the instrument. Additionally, the prior art fail to provide instruments that utilize non-fiat currency assets, such as, but without limitation, real property, personal property, or intellectual property. Moreover, the prior art fail to provide for an instrument that can be utilized for tasks in addition to performing a financial transaction. For example, the prior art fail to provide an instrument capable of performing financial transactions and which is also capable of being used as a key to access a secured system such as a safe, a door, or a vehicle.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a system for asset management comprising a transaction device. The transaction device may include a body member, a printed circuit board (PCB), a controller, a first co-controller, and one or more of another co-controller. The PCB may be housed by the body member and may store onboard user data that may be associated with remote user data stored by a data center. The data center may be operable to be in communication with a third-party device. The controller may be carried by the PCB. The first co-controller may be carried by the PCB and may store security keys that may each associated with one or more of an asset which may be associated with both the remote user data and the onboard user data. The security keys may comprise user specific and unique encrypted security keys. The one or more other co-controller(s) may be carried by the PCB and may store a predetermined subset of the security keys.

The PCB may be operable to receive a transaction request from the third-party device. The one or more other co-controller(s) may be operable to perform a verification procedure which may be based on a portion of the transaction request, a portion of the onboard user data and a portion of the predetermined subset of security keys to determine a transaction authorization and generate a verification result signal based on the transaction authorization. The controller may be operable to send a portion of the onboard user data and the transaction request to the data center responsive to the verification result signal and via the third-party device for the data center to perform at least one predetermined action based thereon.

In some embodiments of the present invention, the transaction device may comprise an antenna, a communication unit, and/or a memory unit that may each be carried by the PCB. Each of the controller, the first co-controller, the one or more other co-controller(s), the antenna, the communication unit, and the memory unit may be integrated into and comprise a single monolithic unit with the PCB. The PCB may be operable to be in communication with and receive power from the third-party device via near-field communication (NFC). The one or more other co-controller(s) may be operable to be functional by an NFC power amount provided by the NFC. The first co-controller may require a predetermined power amount greater than the NFC power amount to be functional.

The one or more other co-controller(s) may comprise a plurality of co-controllers. Each co-controller of the plurality of co-controllers may store a predetermined subset of the security keys that may be different between each one of the plurality of co-controllers. Each co-controller of the plurality of co-controllers may be associated with an asset based on the predetermined subset of the security keys stored thereby. The controller may be operable to identify at least one of the plurality of co-controllers as a relevant co-controller by matching at least a portion of the transaction request with at least one of the predetermined subsets of the security keys.

The security keys may be embedded into the first co-controller and may be inaccessible by the third-party device. The first co-controller may maintain the security keys in an encrypted state. The predetermined subset of the security keys may be embedded into the one or more other co-controller(s) and may be inaccessible by the third-party device. The one or more other co-controller(s) may maintain the predetermined subset of the security keys in an encrypted state. Some embodiments of the present invention may include an additional transaction device. The additional transaction device may store a copy of the security keys, defined as security key copies. The additional transaction device may be operable to provide the data center with access to the security key copies to allow the data center to perform a recovery procedure.

The recovery procedure may comprise one or more of generate and send a deactivation signal to the transaction device, freeze the at least one asset, generate at least one new security key, remove the association of the security keys with the at least one asset, the remote user data and the onboard user data, associate the at least one new security key with the at least one asset and the remote user data, send the at least one new security key to the additional transaction device, and/or generate and send a replacement request to a predetermined manufacturing implementation for fabrication of a new transaction device. The additional transaction device may be positionable in communication with a website to provide the data center with access to the security key copies and to send a recovery request to the data center; and wherein the data center performs the recovery procedure responsive to and based on the recovery request.

Some embodiments of the present invention may be directed to a system for asset management comprising a transaction device and an additional transaction device. The transaction device may store onboard user data, security keys, and/or a predetermined subset of the security keys. The onboard user data may be associated with user data stored by a data center, the security keys each may be associated with at least one asset associated with the remote user data, and the security keys may each comprise user specific and unique encrypted security keys. The additional transaction device may store a copy of the security keys, which may be defined as security key copies.

The transaction device may be operable to receive a transaction request from the third-party device and perform a verification procedure based on at least a portion of the transaction request and the security keys to determine a transaction authorization to generate a verification result signal. The transaction device may be operable to send at least a portion of the onboard user data and the transaction request to the data center responsive to the verification result signal and via the third-party device for the data center to perform at least one predetermined action based therein. The additional transaction device may be operable to provide the data center with access to the security key copies to allow the data center to perform a recovery procedure. The recovery procedure may comprise generating and sending a deactivation signal to the transaction device.

The transaction device may comprise a body member and a printed circuit board (PCB) housed by the body member. The transaction device may include a controller, a first co-controller, one or more of another co-controller, an antenna, a communication unit, and/or a memory unit that may each be carried by the PCB. Each of the controller, the first co-controller, the one or more other co-controller(s), the antenna, the communication unit, and/or the memory unit may be integrated into and comprise a single monolithic unit with the PCB.

The transaction device may be operable to be in communication with and receive power from the third-party device via near-field communication (NFC). The one or more other co-controller(s) may be operable to be functional by an NFC power amount provided by the NFC. The first co-controller may require a predetermined power amount greater than the NFC power amount to be functional. The one or more other co-controller(s) may comprise a plurality of co-controllers. Each co-controller of the plurality of co-controllers may store a predetermined subset of the security keys that may be different between each one of the plurality of co-controllers. Each co-controller of the plurality of co-controllers may be associated with an asset based on the predetermined subset of the security keys stored thereby. The controller may be operable to identify at least one of the plurality of co-controllers as a relevant co-controller by matching at least a portion of the transaction request with at least one of the predetermined subsets of the security keys.

The security keys and the predetermined subset of the security keys may be embedded into the transaction device and may be inaccessible by the third-party device. The transaction device may maintain the security keys and the predetermined subset of the security keys in an encrypted state. The recovery procedure may also include one or more of: freeze the at least one asset, generate at least one new security key, remove the association of the security keys with the at least one asset and with the remote user data, associate the at least one new security key with the at least one asset and with the remote user data, send the at least one new security key to the additional transaction device, and/or generate and send a replacement request to a predetermined manufacturing implementation for fabrication of a new transaction device.

The additional transaction device may be positionable in communication with a website to provide the data center with access to the security key copies and to send a recovery request to the data center. The data center may perform the recovery procedure responsive to and based on the recovery request.

### BRIEF DESCRIPTION OF THE DRAWINGS

Some embodiments of the present invention are illustrated as an example and are not limited by the figures of the accompanying drawings, in which like references may indicate similar elements.

FIG. 1 is a perspective view of an asset management device according to an embodiment of the present invention.

FIG. 2 is a schematic diagram an asset management device according to an embodiment of the present invention in communication with a third-party device and a network.

FIG. 3 is a perspective view and schematic diagram of an asset management device and a mount according to an embodiment of the present invention.

FIG. 4 is a schematic diagram of the asset management device and the mount according to FIG. 3, shown in communication with a third-party apparatus.

FIG. 5 is a perspective view and schematic diagram of an asset management device and an additional asset management device according to an embodiment of the present invention.

FIG. 6 is a schematic diagram of an implantable device according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides an asset management system 100 and an associated asset management device 101 for managing assets and for performing transactions. For the purposes of the description of the present invention herein, the asset management device 101 may alternatively and interchangeably be referred to herein as the device 101, without limitation. The device 101 may be associated with one or more assets owned by a user. The assets may be identified, tracked, and/or managed by a data center 215. The data center 215 may comprise and/or utilize a blockchain 220. The assets may include a variety of fiat assets and non-fiat assets, such as, and without limitation, one or more of fiat currencies, crypto-currencies, real property, personal property, and/or intellectual property. The device 101 may be utilized to perform a transaction with one or more of the assets associated with the device 101. In some embodiments of the present invention, the device 101 may be utilized as a key to allow for access to and management of the assets via the data center 215. The device 101 may yet also be utilized to convert and/or liquidate at least a portion of one or more assets into another type of asset and/or into one or more currencies and/or other currencies. The device 101 may also be utilized to provide access to one or more third-party apparatuses such as a locked safe, a vehicle, and/or a door system.

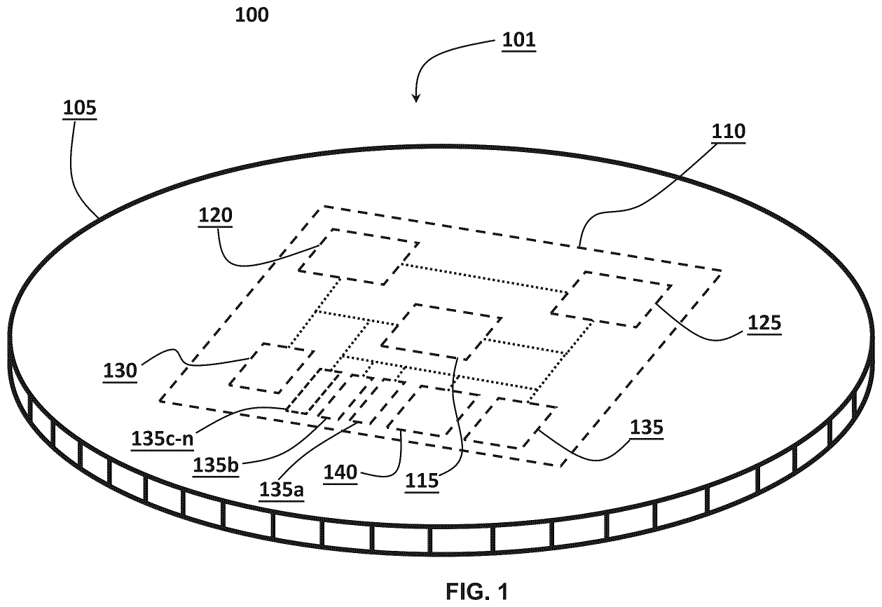

Initially referring to FIG. 1, the device 101 of the system 100 may include a body member 105. The body member 105 may have a geometric shape, such as, and without limitation, a shape similar to a coin. However, it is contemplated that the body member 105 may comprise a number of other shapes, such as, and without limitation, a card, a bracelet, a ring, a necklace, a watch, a sphere, an implantable subdermal device, a cube, and/or a rectangular cube. The device 101 may include a printed circuit board 110 (“PCB”) which may be carried and/or housed by the body member 105. The device 101 and/or the PCB 110 may include one or more of a controller 115, an antenna 120, a communication unit 125, and/or a memory unit 130.

In some embodiments of the present invention, the device 101 and/or the PCB 110 may also include a co-controller 135. The controller 115, antenna 120, communication unit 125, memory unit 130, and/or the co-controller 135 may be mounted and/or carried by the PCB 110. One or more of the controller 115, antenna 120, communication unit 125, memory unit 130, and/or the co-controller 135 may be integrated into the PCB 110, such that the PCB 110 may comprise a single monolithic unit with one or more of the controller 115, antenna 120, communication unit 125, memory unit 130, and/or the co-controller 135 integrated therewith.

The controller 115 may be in communication with one or more of the antenna 120, the communication unit 125, the memory unit 130, and/or the co-controller 135. The controller 115 may be adapted and/or utilized to monitor, control, manage, and/or command one or more of the antenna 120, the communication unit 125, the memory unit 130, and/or the co-controller 135. The controller 115 may be adapted and/or utilized to send, receive, read, write, compute, execute, manage, translate, interpret, and/or perform machine-readable instructions, code, data, commands, executables, information, signals, and/or communications. Examples of the controller 115 include, without limitation, one or more of a central processing unit (CPU), a field-programmable gate array (FPGA), an application specific integrated circuit (ASIC), a microcontroller (MCU), a graphics processing unit (GPU), a digital signal processor (DSP), an embedded processor, a media processor, a system on chip (SoC), and/or an advanced RISC (reduced instruction set computing) machine (“ARM”) processor.

The antenna 120 may be in communication with the controller 115 and/or the communication unit 125. The antenna 120 may be utilized to detect, sense, receive, send, relay, transceive, and/or facilitate communication of machine-readable instructions, code, data, commands, executables, information, signals, and/or machine-readable communications. The antenna 120 may be adapted to provide and/or facilitate communications utilizing near-field communication (NFC), Bluetooth, wireless fidelity (Wi-Fi), and/or radio communication. In some embodiments of the present invention, the antenna 120 may also be adapted to provide and/or facilities communications utilizing one or more of infrared, microwave, optical, supersonic, and/or ultrasonic communication.

Also, in some embodiments of the present invention, the antenna 120 may also be adapted to receive and provide power to one or more of the PCB 110, the controller 115, the communication unit 125, the memory unit 130, and/or the co-controller 135 via wireless power transfer. For example, without limitation, the antenna 120 may be adapted to receive and provide power using near-field wireless power transfer, inductive coupling, resonant inductive coupling, capacitive coupling, and/or far-field wireless power transfer.

The communication unit 125 may be in communication with one or more of the controller 15, the antenna 120, the memory unit 130, and/or the co-controller 135. The communication unit 125 may be adapted and/or utilized to manage, facilitate, and/or control machine-readable communications to be sent by, and/or that are received by, the antenna 120. In some embodiments of the present invention, the communication unit 125 may be adapted to control and/or manage wireless power transfer received by the antenna 120. Also, in some embodiments of the present invention, the communication unit 125 may be adapted to and/or utilized to store power. Examples of the communication unit 125 include, without limitation, a network controller, a power regulator, and/or a power storage unit.

The memory unit 130 may be in communication with one or more of the controller 115, the communication unit 125, and/or the co-controller 135. The memory unit 130 may be adapted and/or utilized to send, receive, read, write, store, provide, and/or manage machine-readable instructions, code, data, commands, executables, information, signals, and/or communications. The memory unit 130 may comprise a flash memory, a solid-state memory, an encrypted memory, a non-volatile machine-readable memory, a volatile machine-readable memory, a random-access memory, a cache memory, a virtual memory, and/or any combination(s) thereof.

Some embodiments of the present invention may include a co-controller 135. The co-controller 135 may be in communication with one or more of the controller 115, the antenna 120, the communication unit 125, and/or the memory unit 130. The co-controller 135 may be adapted and/or utilized to send, receive, read, write, compute, execute, manage, translate, interpret, and/or perform machine-readable instructions, code, data, commands, executables, information, signals, and/or communications. The co-controller 135 may be responsive to a command signal received from the controller 115 to perform one or more of a predetermined co-controller task.

For example, without limitation, the co-controller 135 may be responsive to a command signal received from the controller 115 to perform a predetermined co-controller task, such as, access and process data and/or encrypted data stored by the memory unit 130, process data and/or encrypted data received by the antenna 120, process and provide co-processed data to the controller 115 based on data processed by the co-controller 135, and/or perform one or more of a security check based on data and/or encrypted data received by the antenna 120 and data and/or encrypted data stored by the memory unit 130. Examples of the co-controller 135 include, without limitation, one or more of an CPU, an FPGA, an ASIC, an MCU, a GPU, a DSP, an embedded processor, a media processor, an SoC, and/or an ARM processor.

However, it is contemplated that some embodiments of the present invention may not include a co-controller 135. Moreover, it should be understood that embodiments that do not include a co-controller 135, that some and/or all of the functions, features, and/or limitations of the co-controller 135 described herein may instead be similarly included and/or fully included by and/or in the controller 115 as may be understood by those who may have skill in the art.

In some embodiments of the present invention which may be more preferred, the device 101 may include multiple co-controllers 135, which may be referred to as co-controllers 135a-n. The co-controllers 135a-n may be mounted on and/or carried by the PCB 110. The co-controllers 135a-n may be integrated into the PCB 110, such that the PCB 110 may comprise a single monolithic unit with one or more of the controller 115, antenna 120, communication unit 125, memory unit 130, the co-controllers 135a-n, and the second co-controller 140. The co-controllers 135a-n may be in communication with one or more of another one of the co-controllers 135a-n, the antenna 120, the communication unit 125, the memory unit 130, and/or the first co-controller 135.

The co-controllers 135a-n may be adapted and/or utilized to send, receive, read, write, compute, execute, manage, translate, interpret, and/or perform machine-readable instructions, code, data, commands, executables, information, signals, and/or communications. Examples of each of the co-controllers 135a-n include, without limitation, one or more of an CPU, an FPGA, an ASIC, an MCU, a GPU, a DSP, an embedded processor, a media processor, an SoC, and/or an ARM processor. Each of the co-controllers 135a-n may include a security architecture which may comprise a security architecture that may be different than the security architecture of each of the other co-controllers 135a-n. For example, without limitation, each of co-controller 135a, co-controller 135b and co-controller 135c, may comprise a security architecture that is different from the security architecture of one another. Additionally, each of the co-controllers 135a-n may have a protection level which may be different from the protection level of each of the other co-controllers 135a-n.

Each of the co-controllers 135a-n may be responsive to a command signal received from the controller 115 to perform one or more of a predetermined co-controller task. The predetermined co-controller task may comprise one or more of a lower-level co-controller task and a higher-level co-controller task. Also, the predetermined co-controller task may comprise a first predetermined co-controller task, a second predetermined co-controller task, and/or a third predetermined co-controller task and/or etc. Each of the co-controllers 135a-135n may each be associated with one or more assets and/or one or more asset types that may be different than the asset(s) and/or asset type(s) associated with the other co-controllers 135a-135n. Each of the co-controllers 135a-135n may be operable and/or may operate independently from one another. More details on the co-controllers 135a-135n follows further below.

In some embodiments of the present invention which may be preferred, the device 101 may include two co-controllers 135, 140. For example, and without limitation, in some embodiments of the present invention the device 101 include a co-controller 135 and a second co-controller 140. For the purposes of the description herein of the various embodiments of the present invention, and without limitation, the co-controller 135 may be alternatively and/or interchangeably referred to as a/the first co-controller 135. The second co-controller 140 may be mounted on and/or carried by the PCB 110. The second co-controller 140 may be integrated into the PCB 110, such that the PCB 110 may comprise a single monolithic unit with one or more of the controller 115, antenna 120, communication unit 125, memory unit 130, the first co-controller 135, and the first co-controller 135 integrated therewith. The second co-controller 140 may be in communication with one or more of the controller 115, the antenna 120, the communication unit 125, the memory unit 130, and/or the first co-controller 135.

The second co-controller 140 may be adapted and/or utilized to send, receive, read, write, compute, execute, manage, translate, interpret, and/or perform machine-readable instructions, code, data, commands, executables, information, signals, and/or communications. Examples of the second co-controller 140 include, without limitation, one or more of an CPU, an FPGA, an ASIC, an MCU, a GPU, a DSP, an embedded processor, a media processor, an SoC, and/or an ARM processor. The first co-controller 135 may include a security architecture, which may comprise a security architecture that may be different than the security architecture of the second co-controller 140.

Additionally, the first co-controller 135 may have a protection level that may be different from a protection level of the second co-controller 140. The first co-controller 135 and the second co-controller 140 may be responsive to a command signal received from the controller 115 to perform one or more of a predetermined co-controller task. The predetermined co-controller task may include a predetermined first co-controller task and/or a predetermined second co-controller task. More details about the co-controller 135, the co-controllers 135a-n and the second co-controller 140 follows further below.

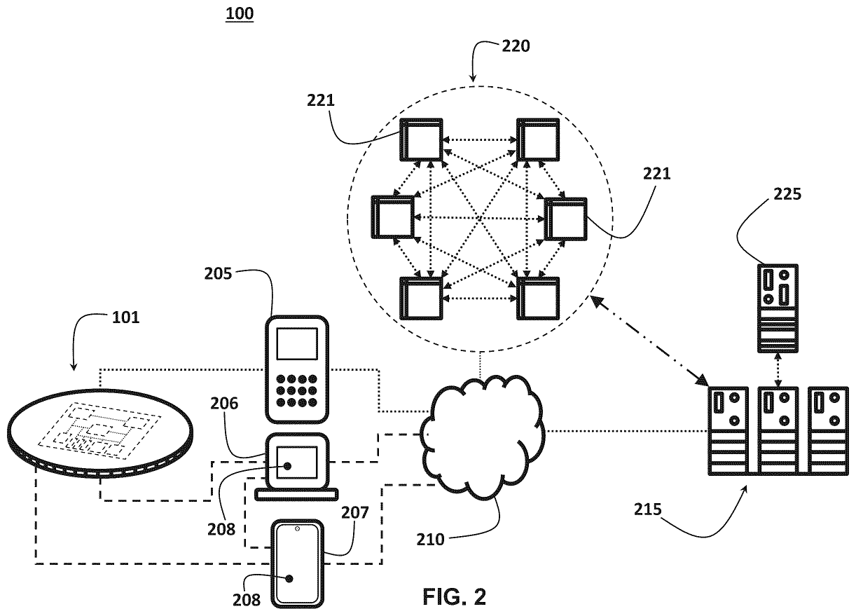

Now referring to FIG. 2, the system 100 may include a data center 215 and/or an asset performer component 225. The data center 215 may comprise and/or utilize a blockchain system 220 as may be understood by those who may have skill in the art. The data center 215 may store user data that may be associated with the device 101. The user data stored by the data center 215 may interchangeably and/or alternatively be referred to as, “remote user data,” without limitation. The user data may comprise one or more of personal user data, user account data, user transaction data, user asset ledger data, user liability data, user security data, user credit data, user preference data, user tax data, and/or user activity data. The data center 215 may be adapted and/or utilized to oversee, monitor, and/or manage the user data associated with the device 101.

The data center 215 may be in communication with an access point 206 and/or with a user device 207. The communication between the data center 215 and the access point 206 and/or the user device 207 may be via a network 210. The access point 206 may also be in communication with the user device 207, which may comprise direct communications between the access point 206 and the user device 207 and/or may comprise communication via the network 210. Examples of the access point 206 may include, without limitation, a personal computer, a laptop computer, a computer tablet, and/or a smartphone and any combination(s) thereof as may be understood by those who may have skill in the art. Examples of the user device 207 may include, without limitation, a smart phone and/or a similar handheld smart computation device. It should be understood, but without limitation, that examples of embodiments referenced herein that include communications between the device 100 and/or data center 215 with both an access point 206 and a user device 207, that the access point 206 may not comprise a smartphone in combination with the user device 207 comprising a smartphone.

The device 101, the memory unit 130, the PCB 110, the co-controller 135, the second co-controller 140 and/or the co-controllers 135a-n may store onboard user data. In some embodiments of the present invention, the onboard user data may comprise encrypted onboard user data. The device 101, the memory unit 130, the co-controller 135, the second co-controller 140 and/or the co-controllers 135a-n may also store one or more user specific and unique encrypted security keys. In some embodiments of the present invention, whether stored thereon and/or thereby, the one or more user specific and unique encrypted security keys may be accessible by one or more of the controller 115, the co-controller 135, the second co-controller 140 and/or the co-controllers 135a-n.

The one or more user specific and unique encrypted security keys may comprise a plurality of layers of encryption, and the one or more user specific and unique encrypted security keys may comprise a plurality of types of encryption. In some embodiments of the present invention, the one or more user specific and unique encrypted security keys may be embedded and/or directly integrated with the memory unit 130, the PCB 110, the co-controller 135, the second co-controller 140 and/or the co-controllers 135a-n. The device 101, the controller 115, the co-controller 135, the second co-controller 140 and/or the co-controllers 135a-n may be configured to never decrypt the user specific and unique encrypted security keys, the onboard user data, and/or the encrypted onboard user data. The device 101, the controller 115, the co-controller 135, the second co-controller 140 and/or the co-controllers 135a-n may be configured to maintain and/or retain the user specific and unique encrypted security keys, the onboard user data, and/or the encrypted onboard user data in their encrypted form(s), such that it is/they are never decrypted by the device 101 and may be maintained and/or retained in an encrypted state and/or an encrypted form.

The onboard user data and/or the encrypted onboard user data may comprise one or more of onboard personal user data, onboard user account data, onboard user transaction data, onboard user asset ledger data, onboard user liability data, onboard user security data, onboard user credit data, onboard user preference data, onboard user tax data, and/or onboard user activity data. For the purposes of the description of the present invention herein, and without limitation, it should be understood that references to the “onboard user data” may imply and/or include reference to “encrypted onboard user data,” such that, the terms “onboard user data” and “encrypted onboard user data” may be used interchangeably and/or alternatively to refer to each thereof individually, in entirely, and/or in combination and without limitation, as may be understood by those who may have skill in the art.

In some embodiments, each portion of the encrypted onboard user data may be associated with one or more of the user specific and encrypted security keys. In some embodiments of the present invention in which the device 101 comprises multiple co-controllers, such as, a first co-controller 135 and a second co-controller 140, and/or a plurality of co-controllers 135a-n, each co-controller 135, 140/135a-n may store, be embedded with, be integrated with, and/or have access to a different portion of the encrypted onboard user data. Also, each co-controller 135, 140/135a-n may store, be embedded with, be integrated with, and/or have access to a different portion of the user specific and encrypted security keys.

The device 101 may be adapted to be positioned in communication with the access point 206 and/or the user device 207. The data center 215 may be adapted to allow the access point 206 and/or the user device 207 to access the user data associated with the device 101, and to allow the access point 206 to view, manage, edit, change, and/or manage the user data. Also, the device 101 may be adapted to be utilized to allow for an access point 206 and/or a user device 207 to access the data center 215 to view, manage, edit, change, and/or manage the user data stored by the data center 215.

A user may operate a website 208 and/or application 208 via the access point 206 and/or the user device 207. For the purposes of the description of the present invention herein, it should be understood that reference to the website 208 and/or application 208 may refer to a machine-readable program, software, executable, and/or application that may be operated, ran, computed, and/or executed by a computer machine as may be understood by those who may have skill in the art, without limitation. Also, for the purposes of the description of the present invention herein, the website 208 and/or application 208 may be referred to as a “website” collectively, individually, and/or in combination, without limitation. The website 208 may be associated with the data center 215, and the website 208 may perform one or more predetermined website actions responsive to one or more website inputs inputted via the access point 206 and/or the user device 207.

The website 208 may receive a website input, which may comprise a user account access request. The website 208 may be responsive to the user account access request to send a user account access request to the device 101 and/or to the data center 215. The user account access request may comprise one or more user credentials which may include one or more of, a geographic location of the access point 206 and/or user device 207, one or more internet and/or hardware address of the access point 207 and/or user device 207, user account name associated with the user data, user password associated with the user data, user pin associated with the user data, user biometric data associated with the user data, and/or a selected user access purpose.

The data center 215 may be adapted to compare the user account access request received to one or more portions of the user data to determine a user account access request result. The user account access request result may comprise a request acceptance, a request denial, and/or a verification request. The data center 215 may send the user account access request result to the website 208 to allow and/or deny access to the user data stored in the data center 215 via the website 208. As noted, in some embodiments of the present invention the user account access request result may comprise a verification request. The verification request may be associated with the user account access request and the verification request may comprise one or more of the user credentials. The website 208 may be configured to display the verification request on the access point 206 and/or on the user device 207. The device 101 may be positioned in communication with the access point 206 and/or the user device 207 to receive the verification request from the website 208.

The device 101 may be responsive to the verification request to perform a security check process. The security check process may include comparing the verification request and/or the user account access request with one or more portions of the onboard user data and/or with one or more of the user specific and unique encrypted security keys to generate and send a verification signal to the access point 206, the user device 207 and/or the website 208 to be relayed to the data center 215. The verification signal may include one or more of an accepted verification, a denied verification, one or more portions of the onboard user data, and/or one or more portions of one or more of the user specific and unique encrypted security keys. The verification signal may also include one or more layers of encryption and/or one or more types of encryption. The data center 215 may be operable to allow and/or deny access to the user data via the website 208 based on the verification signal received by the data center 215.

The controller 115 and/or the co-controller 135 may be operable to perform the security check process responsive to the verification request and may send the verification signal to the access point 206, the user device 207 and/or the website 208 to be relayed thereby to the data center 215. In some embodiments, the controller 115 may relay the verification request to the co-controller 135, and/or the co-controller 135 may be operable to receive the verification request. The co-controller 135 may be operable to perform the security check process responsive to the verification request and to send the verification signal to the controller 115 for the controller 115 to forward the verification signal to the access point 206, the user device 207 and/or to the website 208 for the verification signal to be relayed to the data center 215 thereby and/or therethrough.

In some embodiments of the present invention that include multiple co-controllers, the controller 115 may be responsive to the verification request to identify one or more relevant co-controller(s) 135, 140,/135a-n based on one or more portions of the verification request and/or of the user account access request. For example, without limitation, the controller 115 may be operable to identify one or more relevant co-controller(s) 135, 140,/135a-n based on one or more of the user credentials, such as, and without limitation, the geographic location of the access point 206 and/or user device 207, the one or more internet and/or hardware address of the access point 207 and/or user device 207, the user account name associated with the user data, the user password associated with the user data, the user pin associated with the user data, the user biometric data associated with the user data, and/or the selected user access purpose.

Each of the co-controller(s) 135, 140,/135a-n may be associated with one or more assets and/or asset types. The controller 115 may identify a relevant co-controller 135, 140,/135a-n by matching the selected user access purpose with the asset(s) and/or asset type(s) associated with each of the co-controller(s) 135, 140,/135a-n. For example, without limitation, the second co-controller 140 may be associated with all assets and/or all asset types, and the first co-controller 135 may be associated with a subset of the assets and/or all the asset types, such that the second co-controller 140 may comprise and/or be utilized as a main store and/or main co-controller and the first co-controller 135 may comprise and/or be utilized as a subset store and/or subset co-controller of the assets and/or asset types.

It is contemplated, without limitation, that in embodiments of the present invention that include a first co-controller 135 and a second co-controller 140, the second co-controller 140 may comprise a main asset store and the first co-controller 135 may comprise a subset asset store. Those who may have skill in the art may notice and appreciate that these embodiments may provide for a beneficial configuration of co-controllers wherein the first co-controller 135 may comprise a simpler component than the second co-controller 140, and/or that the first co-controller 135 may require a lower predetermined power amount compared to the second co-controller 140 such that the first co-controller 135 may be functional via lower powered wireless power transfers, such as by near-field communication (NFC) wireless power transfer, to be operable and/or perform one or more of the features and/or functions of the co-controllers described herein.

Moreover, and specifically, the power requirements of a second co-controller 140 utilized as a main asset store may require a higher predetermined power amount which possibly may not be achieved by lower power wireless power transfers such as NFC which generally may provide around one watt of power, and as such, the second co-controller 140 may be limited to being powered by higher power sources, such as, wired power transfer that may provide up to fifteen watts of power to the device 101 and/or the second co-controller 140. Thus, the first co-controller 135 may be operable with NFC, such as NFC with a third-party device 205 to perform a transaction (described more below), and the second co-controller 140 may be operable when a power amount higher than NFC are provided to the device 101 and/or the second co-controller 140 which may be to manage each of the assets associated with the device 101 and/or to manage one or more of the assets associated with the device 101 as described herein.

Moreover, it is contemplated that the communications with, and operations by, the second co-controller 140 are preferably to be utilized with data transfer rates greater than that of NFC, which is typically around 400 kilobits per second. Whereas higher power amounts allow the device 101, the antenna 120 and/or the communication unit 125 to provide communication via Bluetooth communication, which is typically between 1-3 megabits per second. As such, those who may have skill in the art may notice and appreciate that embodiments of the present invention that include a first co-controller 135 and a second co-controller 140 provide a solution by allowing the device 101 to perform and manage up to all aspects of asset management, which typically require power amounts greater than that provided by NFC, while also allowing the device 101 to perform, conduct, and/or facilitate transactions of one or more assets via NFC.

In some embodiments of the present invention, the website 208 may be responsive to the user account access request inputted via the access point 206 and/or the user device 207 to display the verification request therein. Specifically, and without limitation, in contrast to some embodiments of the present invention, in some embodiments of the present invention the verification request may be generated and displayed by the website 208 in response to the user account access request, rather than the data center 215 generating and displaying the verification request to the displayed via the website 208 in response to the user account access request. Also, in some embodiments of the present invention, the website 208 may be adapted to require that the verification signal has been received by the website 208 from the device 101 prior to sending the user account access request to the data center 215. The website 208 may also send the verification signal to the data center 215.

In some embodiments of the present invention, the device 101 may be configured to generate and send an asset consolidation signal to the data center 215 via the website 208, via the access point 206, via the user device 207, and/or via the network 210. The asset consolidation signal may comprise one or more of a portion of the onboard user data and/or a portion of the user specific and unique encrypted security keys. In some embodiments, the device 101 may be responsive to being positioned in communication with the website 208, with the access point 206, with the user device 207, and/or with the network 210 to generate and send the asset consolidation signal to the data center 215. In some embodiments, the device 101 may be adapted to receive the user account access request result generated by the data center 215, and the device 101 may be adapted to be responsive to the request acceptance of the user account access request result received to generate and send the asset consolidation signal to the data center 215.

The data center 215 may be adapted to be responsive to receiving the asset consolidation signal to index, consolidate and/or update at least a portion of the user data with the onboard user data of the asset consolidation signal. The data center 215 may also be adapted to be responsive to receiving the asset consolidation signal to generate and send an asset consolidation response to the device 101. The asset consolidation response may comprise one or more portions of the user data. The device 101 may be responsive to receipt of the asset consolidation response to index, consolidate and/or update at least a portion of the onboard user data with the user data of the asset consolidation response.

As recited above, the data center 215 may be in communication with an asset performer component 225. However, it is contemplated that in some embodiments of the present invention the data center 215 may include the asset performer component 225 such that the asset performer component 225 may be integrated in/with and may comprise a single monolithic unit a part of the data center 215. Additionally, in regard to such embodiments in which the asset performer component 225 is integrated by and/or with the data center 215, that the features, operations, and/or limitations of the asset performer component 225 described herein may be similarly and/or equally applicable to/included by the data center 215 as may be understood by those who may have skill in the art.

The asset performer component 225 may comprise asset conversion data that may be associated with the user data and/or the user asset ledger data stored by the data center 215. The asset performer component 225 may be adapted to perform an asset conversion that may be in response to an asset conversion request made by the data center 215 and/or by the device 101. An asset conversion performed by the asset performer component 225 may comprise the asset performer component 225 causing at least a portion of an asset associated with the user asset ledger data to have a current asset type of the associated asset to be converted to another asset type.

For example, without limitation, the asset performer component 225 may perform the asset conversion to cause at least a portion of an asset associated with the user asset ledger data to be sold, liquidated and/or converted via a predetermined marketplace such that at least a portion of the asset having an asset type, such as, real property, personal property and/or intellectual property, is converted to another asset type, such as, a fiat currency. The asset performer component 225 may be adapted to send a converted asset signal to the data center 215 responsive to, and associated with, the asset conversion. The data center 215 may be responsive to the converted asset signal to index, update and/or consolidate the user asset ledger data and/or the user data based on the converted asset signal. However, it is also contemplated that the asset performer component 225 may also and/or alternatively be adapted to perform the asset conversion to cause an asset comprising any one or more asset types to any one or more other asset types.

For example, without limitation, the asset to convert and/or the converted asset may have any asset type that may comprise one or more of real property, real estate, personal property, intellectual property, a fiat currency, a non-fiat currency, a fractionable asset, a fractionalized asset, a non-fractionable asset, a non-fractionalized asset, a liquid asset, a non-liquid asset, a contract, a stock, a bond, a deed, a title of ownership, a patent, a trademark, a copyright, a royalty, a commodity, a precious metal, gold, silver, platinum, a collectible, a cryptocurrency, an annuity, a mutual fund, an exchange-traded fund (ETF), an option, a futures contract, a lease, a promissory note, an insurance policy, a partnership interest, an equity stake, goodwill, a mineral right, an agricultural asset, a marine vessel, an aircraft, an automobile, an artwork, an antique, a rare item, a collectable, a fine wine, a memorabilia item, a machinery, a geological asset, an environmental credit, and/or a license.

In some embodiments of the present invention, the asset performer component 225 may comprise a third-party system/apparatus of a third-party and/or backend, market-maker and/or broker, which may be separate and apart from the system 100 and in communication with the data center 215. For example, without limitation, the asset performer component 225 may comprise a third-party system of a third-party market-maker that has agreed to provide the asset performer component 225 to provide asset conversion services in cooperation with the system 100 and the data center 215 via an at least partially automated means.

The device 101 may be adapted and/or utilize to perform a transaction with and/or via a third-party device 205, the access point 206, and/or the user device 207. Examples of the third-party device 205 may include, without limitation, any device utilized for financial transactions and/or transfers by a merchant and/or other provider of a good and/or service to a customer. To perform a transaction, the device 101 may be positioned in communication with the third-party device 205. Without limitation, the communication between the device 101 and the third-party device 205 may comprise wireless communication. The device 101 may receive power from the third-party device 205 caused by the communication between the device 101 and the third-party device 205, such as, and without limitation, by at least one of wired power transfer and wireless power transfer as may be understood by those who may have skill in the art. The device 101 may be adapted to receive a transaction request from the third-party device 205. The transaction request may be received by the device 101. The device 101 may be configured to perform a verification procedure responsive to receipt of the transaction request from the third-party device 205.

The transaction request may include one or more of a payment value request, request for one or more asset types, merchant data, and/or merchant security data. The device 101, the controller 115, and/or one or more of the co-controllers 135, 140, 135a-n may perform a verification procedure to determine if the transaction request is authorized. The verification procedure may include comparing at least a portion of the transaction request with one or more of the user specific and unique encrypted security keys to determine if the transaction request is an authorized transaction request provided from a verified merchant.

In some embodiments of the present invention the verification procedure may be performed by the controller 115. Upon determining that the transaction request is authorized, the controller 115 may access the onboard user data stored in the memory unit 130 and the controller 115 may send at least a portion of the onboard user data to the third-party device 205, and/or the device 101 may send at least a portion of the onboard user data to the third-party device 205, such that the onboard user data may be relayed to the data center 215 along with the transaction request, which may be collectively referred to as a pending transaction request.

In some embodiments of the present invention, the device 101, the controller 115, the co-controller 135, may send one or more of the user specific and encrypted security keys to the third-party device 205 upon determining that the transaction request is an authorized transaction request by the verification procedure. It should be understood, without limitation, that for some embodiments of the present invention, references herein to the “pending transaction request” may be defined as also including the one or more user specific and encrypted security keys sent to the third-party device 205 as a result of the verification procedure performed by the device 101.

In some embodiments of the present invention, all and/or a portion of the transaction request may be sent to one or more of the co-controller(s) 135, and/or 140, or 135a-n from the controller 115, and/or all and/or a portion of the transaction request may be received by one or more of the co-controller(s) 135, and/or 140, or 135a-n. The controller 115 may be operable to identify one or more relevant co-controller(s) 135, and/or 140, or 135a-n by comparing and/or matching a portion or more of the transaction request with the asset(s) and/or asset type(s) that each of the co-controller(s) 135, and/or 140, or 135a-n may be associated therewith. The controller 115 may send and/or forward a portion or more of the transaction request to the one or more identified relevant co-controller(s) 135, and/or 140, or 135a-n.

The co-controllers 135, and/or 140, or 135a-n may perform the verification procedure, and the co-controllers 135, and/or 140, or 135a-n may send a verification result signal to the controller 115 as a result of performing the verification procedure, and the controller 115 may be responsive to the verification result signal to send at least a portion of the onboard user data (and/or one or more of the user specific and encrypted security keys) to the third-party device 205.

In some embodiments of the present invention, the data center 215 may utilize a blockchain 220, and the pending transaction request may be sent by the third-party device 205 to the data center 215 via the network 210 and the pending transaction request may be intercepted by the blockchain 220 before the pending transaction request reaches the data center 215. In some other embodiments of the present invention, which may be more preferred, the data center 215 may instead comprise a blockchain 220 and the data center 215 may receive pending transaction request via the network 210.

The blockchain 220 may include a plurality of blockchain nodes 221. Each of the blockchain nodes 221 may comprise a computer-implemented system as may be understood by those who may have skill in the art. Each blockchain node 221 may include separate copies of the user data stored by the data center 215. Each blockchain node 221 may be in communication with one another. The blockchain nodes 221 may be adapted to perform a user data reconciliation check at predetermined check times to determine and correct differences in the separate user data copies stored in the blockchain nodes 221.

Each blockchain node 221 may be configured to perform a blockchain authorization procedure on, and responsive to, the pending transaction request from the third-party device 205. The blockchain authorization procedure may include the blockchain node 221 comparing and verifying the pending transaction request with the separate user data copy stored by that blockchain node 221 to determine and generate a transaction allowability. The transaction allowability may include a tentative authorization, a tentative denial, tentative result data, and tentative action data. The blockchain authorization procedure may also include causing the blockchain node 221 to generate and send a blockchain check request to each of the other blockchain nodes 221 of the blockchain 220.

The blockchain check request may include blockchain node 221 data, a copy of the pending transaction request, and/or the transaction allowability. Each of the blockchain nodes 221 may be responsive to the blockchain check request to perform a blockchain check procedure. The blockchain check procedure may include the blockchain node 221 comparing at least a portion of the blockchain check request and/or the transaction allowability with the separate user data copy stored thereby to determine and generate a blockchain check response which may be associated with the blockchain check request. The blockchain nodes 221 may send the blockchain check response to the blockchain node 221 that sent the blockchain check request associated with the blockchain check response. The blockchain check response may include a check authorization, a check denial, check result data, and/or check action data.

The blockchain node 221 may receive each blockchain check request from each of the other blockchain nodes 221 a part of the blockchain 220. The blockchain node 221 may be adapted to determine and generate a final transaction allowability by comparing each blockchain check request received with the transaction allowability. The blockchain node 221 may determine and generate the final transaction allowability based on matching and comparing each blockchain check response and the transaction allowability with one another. The final transaction allowability may comprise a final authorization, a final denial, final result data, and/or final action data.

The blockchain node 221 may be adapted to take a predetermined action responsive to the final transaction allowability. For example, without limitation, the blockchain node 221 may be adapted to take and/or perform a predetermined action responsive to the final transaction allowability, which may conclude the transaction. The predetermined action taken by the blockchain node 221 may comprise one or more of: generate and send a final authorization signal to the third-party device 205; generate and send a final denial signal to the third-party device 205; send at least a portion of the user data stored by the blockchain node 221 to the third-party device 205; update the user data stored by the blockchain node 221; generate and send an update user data signal to one or more other blockchain nodes 221 a part of the blockchain 220; generate and send a conversion signal to the asset performer component 225 to perform an asset conversion to cause at least a portion of an asset, which may be associated with the user asset ledger data and having a current asset type, to be converted from the current asset type to another asset type based on the transaction request; perform a payment of currency from the user data based on the transaction request; perform a transfer ownership of a least a portion of an asset associated with the user data based on the transaction request, perform a micro-lending procedure to determine whether to provide, and transfer, a loan of funds and/or asset(s) based on one or more portions of the user data and the transaction request.

In some embodiments of the system 100, the device 101 may be configured to commence, perform, make, complete and/or facilitate transactions with a third-party device 205 without the device 101 and/or the third-party device 205 being in communication with a network 210, and/or without the device 101 and/or the third-party device 205 being in communication with the data center 215. It should be understood, without limitation, that the description of such embodiment(s) of the present invention may also be understood to describe and/or relate to one or more method aspects of the present invention. For example, without limitation, the description of such embodiment(s) of the present invention may be understood to also and/or alternatively describing a method of using and/or operating the system 100 and/or device 101 to perform an offline transaction.

The device 101 may be configured to commence, perform, make, complete and/or facilitate transactions comprising an offline transaction. The device 101 and/or one or more of the PCB 110, the controller 115, the memory unit 130 and/or one or more co-controller(s) 135/140/135a-n may store one or more portions of the onboard user data. For example, without limitation, the onboard user data may comprise a copy of one or more portions of the user data stored by the data center 215, including one or more portions of personal user data, user account data, user transaction data, user asset ledger data, user liability data, user security data, user credit data, user preference data, user tax data, and/or user activity data. The onboard user data may comprise a copy of one or more portions of the user data stored by the data center 215. Also, one or more portions of the onboard user data may define vaulted user data.

The vaulted user data may include one or more security features, such as, and without limitation, cybersecurity features, electronic security features, access requirement features, authorization requirement features, encryptions, layers of encryption, and/or security failsafe features as may be understood by those who may have skill in the art. As such, the vaulted user data and/or the security features of the vaulted user data may inhibit, restrict, and/or entirely prevent a user from accessing, reading, viewing, and/or changing any portion of the vaulted user data, which may include, without limitation, any direct input or action by a user—outside of—performing a transaction using the device 101 and/or accessing, changing, and/or managing the user data stored in the data center 215 associated with the device 101 and/or the onboard user data.

For example, the vaulted user data may be inaccessible, non-readable, and/or non-changeable by a website 208, access point 206, and/or user device 207 that may be in communication with the device 101. However, the vaulted user data may be accessible, readable, and/or changeable by the controller 115 and/or the co-controller(s) 135/140/135a-n, which may be in relation to and/or responsive to signal(s) received by the device 101 from the data center 215 and/or received from a third-party device 205 in relation to a transaction, such as, and without limitation, in relation to an offline transaction. It should be understood, that for the purposes of the description of the present invention, the term “offline transaction” may refer to a transaction and/or payment made via electronic devices and/or electronic means without the use of, and/or without the ability to use/be in communication with, a network 210 and/or the data center 215.

The device 101, the controller 115, and/or the communication unit 125 may be configured, adapted, and/or operable to detect and/or determine if a network 210 is in communication therewith and/or with the third-party device 205 to make an offline determination and/or an online determination. Based on the online determination, the device 101 may perform a transaction that utilizes and/or includes the network 210 and/or data center 215 as described herein. Based on the offline determination, the device 101, the controller 115, and/or the co-controller(s) 135/140/135a-n, during a transaction, may be responsive to the verification result signal to, and/or may as a result of the verification procedure, perform an offline payment determination to generate and/or send an offline transaction denial signal and/or an offline transaction acceptance signal to the third-party device 205. Also, based on the offline determination, the device 101, the controller 115, and/or the co-controller(s) 135/140/135a-n, during a transaction, may be responsive to the verification result signal to, and/or may as a result of the verification procedure, perform an offline payment determination to generate and send an offline payment signal to the third-party device 205.

The offline payment determination may include one or more of accessing and/or reading the vaulted user data, and/or may include matching and/or comparing one or more portions of the vaulted user data with one or more portions of the transaction request to generate an offline payment allowance, an offline payment denial, and/or an offline credit determination. The offline credit determination may include the device 101, the controller 115, and/or the co-controller(s) 135/140/135a-n generating a credit allowance based on the vaulted user data and/or the transaction request. The device 101, controller 115, and/or co-controller(s) 135/140/135a-n may update and/or index the vaulted user data with the credit allowance. The device 101, controller 115, and/or co-controller(s) 135/140/135a-n may store the offline payment determination, the offline payment allowance, the offline payment denial, the offline credit determination, and/or the credit allowance data in/with the onboard user data and/or the vaulted user data.

The offline payment signal may be generated based on the vaulted user data and the transaction request, and/or the offline payment signal may be generated based on one or more of the offline payment determination, the offline payment allowance, the offline payment denial, the offline credit determination, and/or the credit allowance. The device 101, controller 115, and/or co-controller(s) 135/140/135a-n may send the offline payment signal to be received by the third-party device 205. The third-party device 205 may generate and send a transaction result signal to be received by the device 101, the controller 115, and/or the co-controller(s) 1355/140/135a-n.

The transaction result signal may include one or more of a transaction acceptance signal, a transaction completion signal, a transaction pending signal, a transaction decline signal, and/or a transaction failure signal. The transaction result signal may also include one or more of payment amount data, payment asset type data, merchant data, time/timestamp data, geographic location data, purchased goods and/or services data, and/or merchant security data. The device 101, controller 115, and/or co-controller(s) 135/140/135a-n may configured update the vaulted user data with the transaction result signal, store the transaction result signal in the vaulted user data, index the transaction result signal with the vaulted user data, and/or consolidate the transaction result signal with the vaulted user data. The device 101, controller 115, and/or co-controller(s) 135/140/135a-n may generate a vaulted user data update reminder responsive to receiving the transaction result signal.

The device 101, controller 115, and/or co-controller(s) 135/140/135a-n may be configured to generate and send a vaulted user data consolidation signal to the data center 215 responsive to being positioned in communication with a network 210 and/or the data center 215 via a network 210. In some embodiments of the present invention, the device 101, controller 115, and/or co-controller(s) 135/140/135a-n may be configured to generate and send a vaulted user data consolidation signal to the data center 215 based on the vaulted user data update reminder and responsive to being positioned in communication with a network 210 and/or the data center 215 via a network 210. The vaulted user data consolidation signal may include and/or generated based on at least a portion of the vaulted user data, the offline payment signal, the transaction signal, and/or the transaction result signal. The data center 215 and/or the device 101 may be operable to perform a user data consolidation process to consolidate and/or update the user data and/or the vaulted user data based on the vaulted user data consolidation signal.

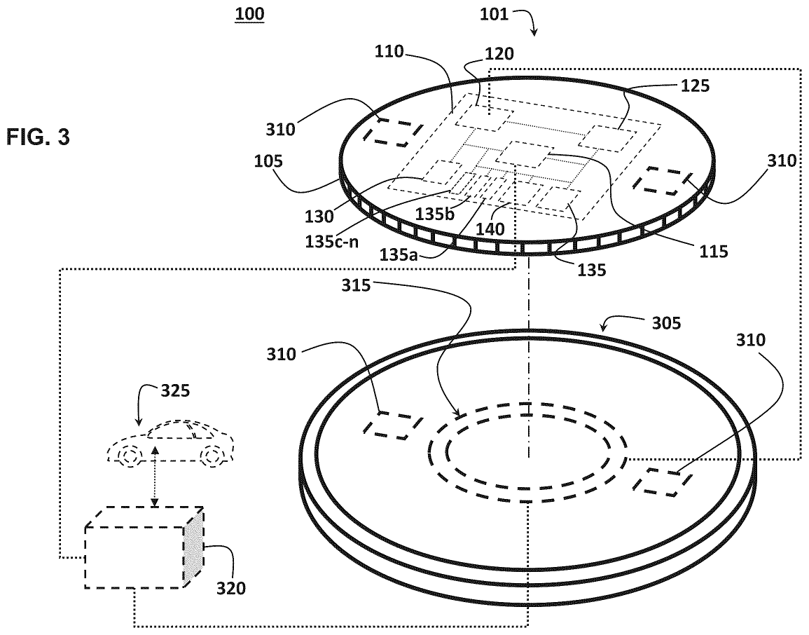

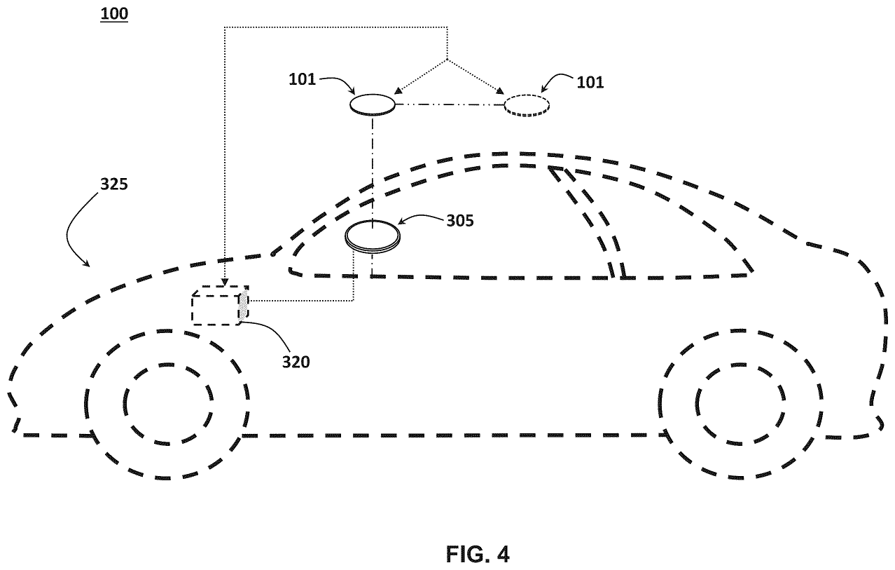

Now referring to FIGS. 3-4, in some embodiments of the present invention the device 101 may be utilized as an activator and/or authorizer of one or more third-party apparatuses 325. For example, without limitation, the device 101 may be utilized as a key, a wireless digital key, and/or an electronic key to unlock, activate, access, and/or operate one or more third-party apparatuses 325. The third-party apparatuses 325 may include a vehicle, as illustrated in FIGS. 3-4. However, it is contemplated that third-party apparatuses 325 may include any apparatus, device, and/or system that may be activated, unlocked, accessed, and/or operated by a key, a wireless digital key, and/or an electronic key as may be understood by those who may have skill in the art. Additional examples of third-party apparatuses 325 includes, without limitation, an electronic safe, a lockbox, a briefcase, a vault, a glovebox, a weapon case, a digital lock such as a digital padlock, a door, a door-lock, a computer machine, a handheld smart device, and any other device or apparatus as my be understood by those who may have skill in the art.

The device 101 may be adapted to be positioned in communication with a third-party apparatus 325, and the communication between the device 101 and the third-party apparatus 325 may comprise wireless communication. The device 101 may be adapted to be positioned in communication with a third-party apparatus 325 upon the device 101 and/or the antenna 120 of the device 101 being within a predetermined proximity range with the third-party apparatus 325. The device 101 may be configured to send one or more access signals to the third-party apparatus 325. The access signal may be received by the third-party apparatus 325 to cause the third-party apparatus 325 to become unlocked, activated, and/or change or maintain a behavior, status, and/or state of the third-party apparatus 325 as may be understood by those who may have skill in the art. For example, without limitation, the third-party apparatus 325 may change to and/or maintain an operable state from a non-operable state upon receiving the access signal from the device 101.

Some embodiments of the present invention may include a mount 305. The mount 305 may be adapted to be carried by a third-party apparatus 325, and the mount 305 may be installed and/or integrated with a third-party apparatus 325. The mount 305 may be positioned in communication with a third-party controller 320 of the third-party apparatus 325. The mount 305 may be adapted to support, carry, and/or removably engage with the device 101. The device 101 may include one or more retention units 310, which may be carried by the body member 105. The mount 305 may also include one or more retention units 310. In some embodiments of the present invention, the device 101 and the mount 305 may each include the same number of retention units 310 therein, and the retention units 310 of the device 101 may be positioned to be positioned adjacent to a corresponding retention unit 310 of the mount 305 when the device 101 is supported, carried, and/or removably engaged with the mount 305.

The retention units 310 may be adapted to generate a retention force with another retention unit 310 when the retention units 310 are positioned in a predetermined near proximity with one another. The retention force generated by the retention units 310 may cause the device 101 and the mount 305 to be forcibly attracted to one another. Examples of the retention units 310 include, without limitation, an electromagnet, a permanent magnet, a temporary magnet, a flexible magnet, and any other magnet as may be understood by those who may have skill in the art.

The mount 305 may include a mount communicator 315. The mount communicator 315 may be positioned in communication with the third-party controller 320, and the mount communicator 315 may be adapted to be in communication with the device 101 when the device 101 is supported, carried, and/or removably engaged with the mount 305. The mount communicator 315 may be adapted to provide and/or transfer power to the device 101 while the device 101 is supported, carried, and/or removably engaged with the mount 305. For example, without limitation, the mount communicator 315 may provide and/or transfer power to the device 101 via wireless power transfer, and the mount communicator 315 may cooperate with the antenna 130 of the device 101 to provide and/or transfer power to the device 101.

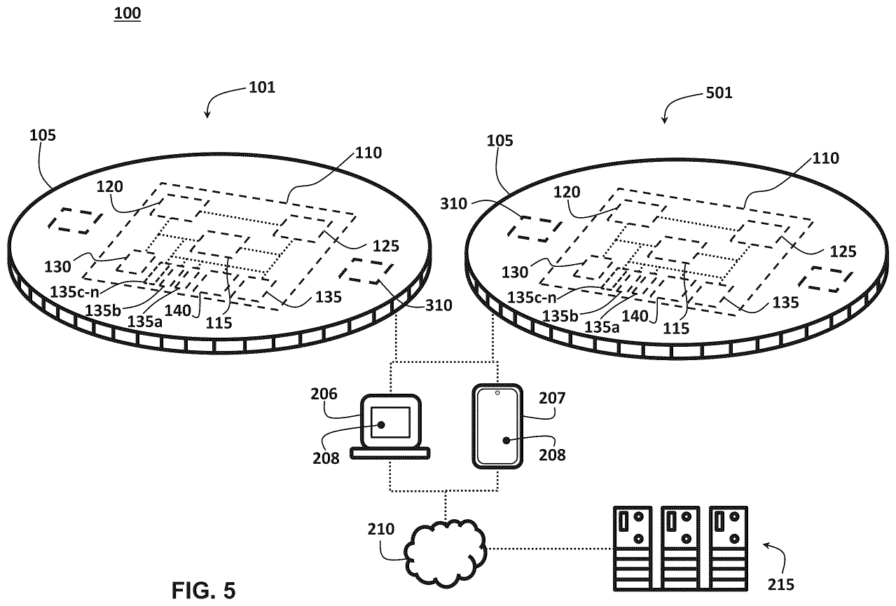

Now referring to FIG. 5, some embodiments of the system 100 may include an additional device 501 that may be associated with the device 101. The additional device 501 may comprise one or more of the same and/or similar components, features, and/or functions as discussed herein regarding the device 101. For example, without limitation, the additional device 501 may include one or more of the same and/or similar components as the device 101 as discussed herein, such as, the body member 105, the PCB 110, the controller 115, the antenna 120, the communication unit 125, the memory unit 130, the (first) co-controller 135, the second co-controller 140, the co-controllers 135a-n, and/or the retention unit(s) 310. However, without limitation, it is contemplated that in some embodiments of the present invention, that the additional device 501 may not include each and every component, feature, and/or function as the device 101 that the additional device 501 may be associated therewith.

In some embodiments, the body member 105 of the device 101 and the body member 501 of the additional device may both comprise the same and/or similar style, look, shape, and/or material(s). In some other embodiments of the present invention, the body member 105 of the device 101 and the body member 501 of the additional device may each comprise a style, look, shape, and/or material(s) that may be different from one another. For example, without limitation, the body member 105 of the device 101 may comprise a precious metal, and the body member 105 of the additional device 501 may comprise a less valuable material, such as, and without limitation, a non-precious metal, a plastic, a composite material, and/or a type of wood.

The additional device 501 may include the one or more of the same and/or one or more copies of the user specific and encrypted security keys as the device 101 that the additional device 501 may be associated with. Also, the additional device 501 may include the same and/or a copy of a portion or more of the user data as the associated device 101. Without limitation, it is preferred that in the embodiments of the present invention, that any access to and/or actions with/regarding the assets associated with the device 101 as described herein may only be allowed with the device 101 and/or by utilizing the device 101 as described herein. Such as, and without limitation, that in embodiments of the present invention that the device 101 must be utilized to perform a security check process to complete a user account access request, and/or to perform a verification procedure to complete a transaction request.

Ergo, the ability to access the assets and/or the ability conduct transactions with the assets may be unavailable without possession of the device 101. For example, without limitation, possession of the device 101 may be unavailable by the device 101 being misplaced, lost, abandoned, stolen, dispossessed, destroyed, unrecoverable, mislaid, and/or otherwise absent from an owner thereof and/or from the person of an owner thereof. In some embodiments of the present invention the additional device 501 may be utilized to deactivate, invalidate, and/or void the device 101, such that the device 101 may be disassociated with one or more of the assets that may be associated with the device 101, and/or such that one or more portions of the data, onboard user data, and/or user specific and unique encrypted security keys are removed from the device 101 and/or rendered unreadable and/or corrupted. Without limitation, it is contemplated that the additional device 501 would be stored, secured, and/or hidden in a relatively safe location, area, and/or container to be obtained and utilized upon the owner losing possession of the device 101.

The additional device 501 may be positioned in communication with the data center 215, which may be communication via an access point 206 and/or a user device 207. The website 208 may receive a website input which may comprise a recovery request. The website 208 may be responsive to the recovery request to send the recovery request to the data center 215. The recovery request may comprise one or more of the user credentials described above. In some embodiments of the system 100, the website 208 may be responsive to the recovery request to generate and display a two-factor authentication request to the user device 207 and/or the access point 206 to request a two-factor authentication response associated with the device 101 and/or with the additional device 501 to be sent to the website 208 and/or the data center 215 from the user device 207 and/or the access point 206.

In some embodiments of the present invention the data center 215 may be responsive to the recovery request to generate and send a two-factor authentication request to the user device 207, the access point 206, and/or the website 208 to be displayed by the website 208, by the user device 207, and/or by the access point 206 to request a two-factor authentication response associated with the device 101 and/or with the additional device 501 to be sent to the website 208 and/or the data center 215 from the user device 207 and/or the access point 206. Additionally, in some embodiments of the present invention, the website 208 and/or the data center 215 may be responsive to the recovery request to generate one or more security checks to be displayed on the website 208 at the user device 207 and/or access point 206 requesting one or more website inputs comprising one or more security inputs to be sent to the website 208 and/or the data center 215 via the access point 206 and/or the user device 207. For example, without limitation, the one or more security inputs may comprise one or more of a security question, user social security number, user photo identification, user birth certificate, user biometric authentication, a security token, user email verification, user phone verification, a multi-factor authentication, and/or a security certificate.

The data center 215 may be operable to match the recovery request, the two-factor authentication response, and/or the security input(s) to one or more portions of the user data to determine a recovery procedure initiation. The data center 215 may be responsive to perform a recovery procedure based on the recovery procedure initiation. The recovery procedure performed by the data center 215 may include one or more of requesting and receiving the one or more user specific and unique encrypted security keys from the additional device 501, decrypting and/or reading the one or more user specific and unique encrypted security keys, comparing and/or matching the one or more user specific and unique encrypted security keys to the user data, and/or generating and sending a deactivation signal to be received by the device 101 to cause that device 101 to delete and/or corrupt at least a portion of the onboard user data and/or the one or more user specific and unique encrypted security keys.

The recovery procedure performed by the data center 215 may also include one or more of freezing the assets that are associated with the device 101, freezing and/or canceling any pending transaction request by the device 101, generating one or more new user specific and unique encrypted security keys (alternatively, without limitation, “new security key(s)”), replacing the association between the user data and/or the assets of the device 101 and the one or more user specific and unique encrypted security keys with an association with the one or more new security keys and. Additionally, the recovery procedure performed by the data centers 215 may include one or more of sending the new security key(s) to the additional device 501 for the device 501 to replace the user specific and unique security keys stored thereon with the new security key(s), and/or generating and sending a replacement request to a predetermined manufacturing implementation based on one or more of the recovery request, the user data, the security key(s), and/or new security key(s) for at least one new device 101 and/or new additional device 501 to be fabricated and/or for the user assets to be associated with the new device(s) 101 and/or the new additional device(s) 501.

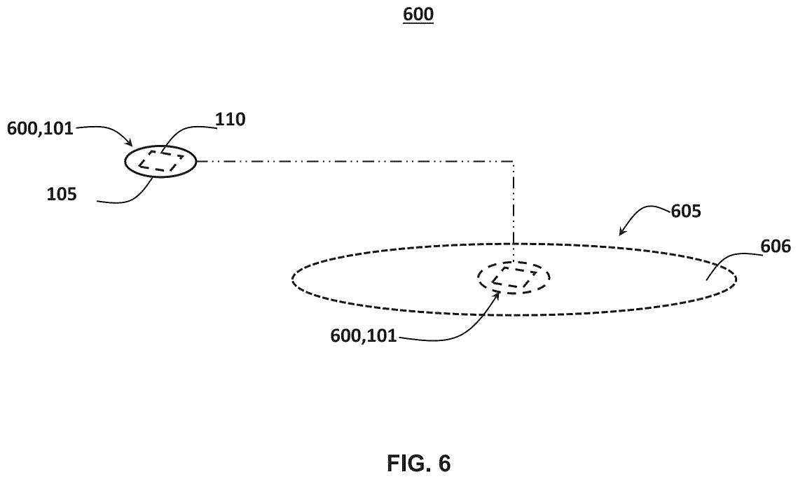

Now referring to FIG. 6, in some embodiments of the system 100 the device 101 may comprise an implantable device 600. The device 600, 101 and/or the body member 105 of the device 600, 101 may be configured and/or adapted to be implanted into a portion and/or area of a body part 605 of a user and/or may be implantable within and/or underneath at least a portion of the skin 606 of the body 605 of a user. As such, the device 101 and/or the body member 105 may be sub-dermally implanted and/or subcutaneously implanted, as illustratively shown in FIG. 6. The device 600, 101 and/or the body member 105 may comprise one or more material(s) that may be biocompatible, non-toxic, non-reactive with immune systems, corrosion resistant, anti-bacterial, anti-viral, and/or non-magnetic and/or any other material suitable for the implantable device 600, 101 as may be understood by those who may have skill in the art.

Embodiments of the implantable device 600 may include one or more of the same and/or similar features, functions, adaptations, configurations, and/or operations as the device 101 and its various members and/or components as described throughout herein. For example, without limitation, the implantable device 600 may have the same features and functions as described above regarding the device 101 communicating with and controlling a third-party apparatus 325. More specifically, the device 600 may also be adapted to be positioned in communication with a third-party apparatus 325, and the communication between the device 600 and the third-party apparatus 325 may comprise wireless communication. The device 600 may also be adapted to be positioned in communication with a third-party apparatus 325 upon the device 600 and/or the antenna 120 of the device 600 being within a predetermined proximity range with the third-party apparatus 325. The device 600 may yet also be configured to send one or more access signals to the third-party apparatus 325. The access signal may be received by the third-party apparatus 325 to cause the third-party apparatus 325 to become unlocked, activated, and/or change or maintain a behavior, status, and/or state of the third-party apparatus 325 as may be understood by those who may have skill in the art. For example, without limitation, the third-party apparatus 325 may change to and/or maintain an operable state from a non-operable state upon receiving the access signal from the device 101.

Additionally, in some embodiments of the device 600, 101, additional data and/or information may be stored thereon. For example, without limitation, in some embodiments of the device 600, 101, the PCB 110 and/or the memory unit 130 store one or more of a user address, user contact data, user emergency contact data, user family contact data, user employment data, user work history data, user allergy data, user medical information data, user insurance data, user birth certificate, user identification data, user passport, and/or user legal record data, which may be referred to collectively, individually, alternatively, and/or in any combination(s) thereof as “additional data.” The additional data may be accessed by a third-party device 205, an access point 206, and/or a user device 207. The additional data may be provided to an accessing device following a security check performed based on an access request signal received by the device 600, 101.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus, the scope of the invention should be determined by the appended claims and their legal equivalents, and not by the examples given.

What is claimed is:

1. A system for asset management comprising:
a transaction device comprising:
a body member;
a printed circuit board (PCB) housed by the body member and storing onboard user data associated with remote user data stored by a data center, the data center being operable to be in communication with a third-party device;
a controller carried by the PCB;
a first co-controller carried by the PCB and storing security keys that are each associated with at least one asset that is associated with both the remote user data and the onboard user data, the security keys comprising user specific and unique encrypted security keys; and
at least one of another co-controller carried by the PCB, the at least one other co-controller storing a predetermined subset of the security keys;
wherein the PCB is operable to receive a transaction request from the third-party device;
wherein the at least one other co-controller is operable to perform a verification procedure based on at least a portion of the transaction request, the onboard user data and the predetermined subset of security keys to determine a transaction authorization and generate a verification result signal based on the transaction authorization; and
wherein the controller is operable to send at least a portion of the onboard user data and the transaction request to the data center responsive to the verification result signal and via the third-party device for the data center to perform at least one predetermined action based thereon.

2. The system of claim 1, wherein the transaction device comprises an antenna, a communication unit, and a memory unit that are each carried by the PCB; and wherein each one of the controller, the first co-controller, the at least one other co-controller, the antenna, the communication unit, and the memory unit are integrated into and comprise a single monolithic unit with the PCB.

3. The system of claim 1, wherein the PCB is operable to be in communication with and receive power from the third-party device via near-field communication (NFC); wherein the at least one other co-controller is operable to be functional by an NFC power amount provided by the NFC; and wherein the first co-controller requires a predetermined power amount greater than the NFC power amount to be functional.

4. The system of claim 1, wherein the at least one other co-controller comprises a plurality of co-controllers; wherein each co-controller of the plurality of co-controllers stores a predetermined subset of the security keys that is different between each one of the plurality of co-controllers; wherein each co-controller of the plurality of co-controllers is associated with an asset based on the predetermined subset of the security keys stored thereby; and wherein the controller is operable to identify at least one of the plurality of co-controllers as a relevant co-controller by matching at least a portion of the transaction request with at least one of the predetermined subsets of the security keys.

5. The system of claim 1, wherein the security keys are embedded into the first co-controller and are inaccessible by the third-party device; wherein the first co-controller maintains the security keys in an encrypted state; wherein the predetermined subset of the security keys are embedded into the at least one other co-controller and are inaccessible by the third-party device; and wherein the at least one other co-controller maintains the predetermined subset of the security keys in an encrypted state.

6. The system of claim 1, further comprising an additional transaction device; wherein the additional transaction device stores a copy of the security keys, defined as security key copies; and wherein the additional transaction device is operable to provide the data center with access to the security key copies to allow the data center to perform a recovery procedure.

7. The system of claim 6, wherein the recovery procedure comprises at least one of generate and send a deactivation signal to the transaction device, freeze the at least one asset, generate at least one new security key, remove the association of the security keys with the at least one asset, the remote user data and the onboard user data, associate the at least one new security key with the at least one asset and the remote user data, send the at least one new security key to the additional transaction device, and generate and send a replacement request to a predetermined manufacturing implementation for fabrication of a new transaction device.

8. The system of claim 6, wherein the additional transaction device is positionable in communication with a website to provide the data center with access to the security key copies and to send a recovery request to the data center; and wherein the data center performs the recovery procedure responsive to and based on the recovery request.

9. A system for asset management comprising:
a transaction device that stores onboard user data, security keys, and a predetermined subset of the security keys, the onboard user data associated with user data stored by a data center, the security keys each being associated with at least one asset associated with the remote user data and comprising user specific and unique encrypted security keys; and
an additional transaction device that stores a copy of the security keys defined as security key copies;
wherein the transaction device is operable to receive a transaction request from the third-party device and perform a verification procedure based on at least a portion of the transaction request and the security keys to determine a transaction authorization to generate a verification result signal;
wherein the transaction device is operable to send at least a portion of the onboard user data and the transaction request to the data center responsive to the verification result signal and via the third-party device for the data center to perform at least one predetermined action based therein;
wherein the additional transaction device is operable to provide the data center with access to the security key copies to allow the data center to perform a recovery procedure; and
wherein the recovery procedure comprises generating and sending a deactivation signal to the transaction device.

10. The system of claim 9, wherein the transaction device comprises a body member and a printed circuit board (PCB) housed by the body member; wherein the transaction device includes a controller, a first co-controller, at least one of another co-controller, an antenna, a communication unit, and a memory unit that are each carried by the PCB; and wherein each one of the controller, the first co-controller, the at least one other co-controller, the antenna, the communication unit, and the memory unit are integrated into and comprise a single monolithic unit with the PCB.

11. The system of claim 10, wherein the transaction device is operable to be in communication with and receive power from the third-party device via near-field communication (NFC); wherein the at least one other co-controller is operable to be functional by an NFC power amount provided by the NFC; and wherein the first co-controller requires a predetermined power amount greater than the NFC power amount to be functional.

12. The system of claim 10, wherein the at least one other co-controller comprises a plurality of co-controllers; wherein each co-controller of the plurality of co-controllers stores a predetermined subset of the security keys that is different between each one of the plurality of co-controllers; wherein each co-controller of the plurality of co-controllers is associated with an asset based on the predetermined subset of the security keys stored thereby; and wherein the controller is operable to identify at least one of the plurality of co-controllers as a relevant co-controller by matching at least a portion of the transaction request with at least one of the predetermined subsets of the security keys.

13. The system of claim 9, wherein the security keys and the predetermined subset of the security keys are embedded into the transaction device and are inaccessible by the third-party device; and wherein the transaction device maintains the security keys and the predetermined subset of the security keys in an encrypted state.

14. The system of claim 9, wherein the recovery procedure further comprises at least one of freeze the at least one asset, generate at least one new security key, remove the association of the security keys with the at least one asset and with the remote user data, associate the at least one new security key with the at least one asset and with the remote user data, send the at least one new security key to the additional transaction device, and generate and send a replacement request to a predetermined manufacturing implementation for fabrication of a new transaction device.

15. The system of claim 9, wherein the additional transaction device is positionable in communication with a website to provide the data center with access to the security key copies and to send a recovery request to the data center; and wherein the data center performs the recovery procedure responsive to and based on the recovery request.

16. A system for asset management comprising:
a transaction device comprising:
a body member;
a printed circuit board (PCB) housed by the body member and storing onboard user data associated with user data stored by a data center, the data center being operable to be in communication with a third-party device;
a controller carried by the PCB;
a first co-controller carried by the PCB and storing security keys that are each associated with at least one asset that is associated with both the remote user data and the onboard user data, the security keys comprising user specific and unique encrypted security keys; and
at least one of another co-controller carried by the PCB, the at least one other co-controller storing a predetermined subset of the security keys;
wherein the PCB is operable to receive a transaction request from the third-party device;
wherein the at least one other co-controller is operable to perform a verification procedure based on at least a portion of the transaction request, the onboard user data and the predetermined subset of security keys to determine a transaction authorization and generate a verification result signal based on the transaction authorization;
wherein the controller is operable to send at least a portion of the onboard user data and the transaction request to the data center responsive to the verification result signal and via the third-party device for the data center to perform at least one predetermined action based thereon; and
wherein the PCB is operable to be in communication with and receive power from the third-party device via near-field communication (NFC);
wherein the at least one other co-controller is operable to be functional by an NFC power amount provided by the NFC; and
wherein the first co-controller requires a predetermined power amount greater than the NFC power amount to be functional; and
an additional transaction device that stores a copy of the security keys defined as security key copies;
wherein the additional transaction device is operable to provide the data center with access to the security key copies to allow the data center to perform a recovery procedure that comprises at least one of generate and send a deactivation signal to the transaction device, freeze the at least one asset, generate at least one new security key, remove the association of the security keys with the at least one asset, the remote user data and the onboard user data, associate the at least one new security key with the at least one asset and the remote user data, send the at least one new security key to the additional transaction device, and generate and send a replacement request to a predetermined manufacturing implementation for fabrication of a new transaction device.

17. The system of claim 16, wherein the at least one other co-controller comprises a plurality of co-controllers; wherein each co-controller of the plurality of co-controllers stores a predetermined subset of the security keys that is different between each one of the plurality of co-controllers; wherein each co-controller of the plurality of co-controllers is associated with an asset based on the predetermined subset of the security keys stored thereby; and wherein the controller is operable to identify at least one of the plurality of co-controllers as a relevant co-controller by matching at least a portion of the transaction request with at least one of the predetermined subsets of the security keys.

18. The system of claim 16, wherein the security keys are embedded into the first co-controller and are inaccessible by the third-party device; wherein the first co-controller maintains the security keys in an encrypted state; wherein the predetermined subset of the security keys are embedded into the at least one other co-controller and are inaccessible by the third-party device; and wherein the at least one other co-controller maintains the predetermined subset of the security keys in an encrypted state.

19. The system of claim 16, wherein the additional transaction device is positionable in communication with a website to provide the data center with access to the security key copies and to send a recovery request to the data center; and wherein the data center performs the recovery procedure responsive to and based on the recovery request.

20. The system of claim 16, wherein the transaction device comprises an antenna, a communication unit, and a memory unit that are each carried by the PCB; and wherein each one of the controller, the first co-controller, the at least one other co-controller, the antenna, the communication unit, and the memory unit are integrated into and comprise a single monolithic unit with the PCB.
